(19) United States
(12) Patent Application Publication
(10) Pub. No.: US 2014/0136963 A1
(43) Pub. Date: May 15, 2014

(54) INTELLIGENT INFORMATION SUMMARIZATION AND DISPLAY

(71) Applicant: Steve Xi Chen, Mountain View, CA (US)

(72) Inventor: Steve Xi Chen, Mountain View, CA (US)

(21) Appl. No.: 14/079,106

(22) Filed: Nov. 13, 2013

Related U.S. Application Data
(60) Provisional application No. 61/725,874, filed on Nov. 13, 2012.

(51) Int. Cl. G06F 17/21

(52) U.S. Cl. CPC G06F 17/211
USPC 715/254

(57) ABSTRACT

Information summarization and display systems and methods are provided herein. A method includes receiving informational content from an informational content provider, the informational content comprising textual content, extracting the textual content from the informational content; analyzing words in the textual content as well as their relative positions in the textual content to determine one or more key topics for the textual content, extracting one or more sentences from the textual content that are most indicative of the one or more key topics, and generating a graphical user interface that includes a summary display.

### CROSS REFERENCE TO RELATED APPLICATIONS

This Non-Provisional U.S. patent application claims the priority benefit of U.S. Provisional Application Ser. No. 61/725,874, filed on Nov. 13, 2012, which is hereby incorporated by reference herein in its entirety including all references cited therein. This application is also related to U.S. Provisional Application Ser. No. 61/730,600, filed on Nov. 30, 2012; and U.S. Provisional Application Ser. No. 61/731,607, filed on Nov. 30, 2012, all of which are hereby incorporated by reference herein in their entireties including all references cited therein.

### FIELD OF THE INVENTION

The present technology is generally directed to information gathering and display, and more specifically, but not by way of limitation, to systems and methods that gather, analyze, summarize, and display information to end users in a compact and easily viewable manner.

### SUMMARY

According to some embodiments, the present technology is directed to a method that includes: (a) receiving informational content from an informational content provider, the informational content comprising textual content; (b) extracting the textual content from the informational content; (c) analyzing words in the textual content as well as their relative positions in the textual content to determine one or more key topics for the textual content; (d) identifying one or more key topics in the textual content from an analysis of any of the word identifiers, the sentence identifiers, the paragraph identifiers, and combinations thereof; (e) extracting one or more sentences from the textual content that are most indicative of the one or more key topics; and (f) generating a graphical user interface that includes a summary display, the summary display comprising at least the extracted one or more sentences.

According to some embodiments, the present technology is directed to a system that includes: (a) a processor; and (b) logic encoded in one or more tangible media for execution by the processor, the logic when executed by the processor causing the system to: (i) receive informational content from an informational content provider, the informational content comprising textual content; (ii) extract the textual content from the informational content; (iii) analyzing words in the textual content as well as their relative positions in the textual content to determine one or more key topics for the textual content; (iv) identify one or more key topics in the textual content from an analysis of any of the word identifiers, the sentence identifiers, the paragraph identifiers, and combinations thereof; (v) extract one or more sentences from the textual content that are most indicative of the one or more key topics; and (vi) generate a graphical user interface that includes a summary display, the summary display comprising the extracted one or more sentences.

According to some embodiments, the present technology is directed to a method that includes: (a) receiving a query from a client, the query comprising one or more search terms; (b) identifying online content for the one or more search terms, the online content comprising textual content; (c) retrieving the informational content that was identified; (d) performing a frequency occurrence analysis on the online content to determine words in the online content that have a highest frequency of occurrence; (e) identifying one or more key topics in the online content based upon the frequency occurrence analysis; (f) creating a summary of the online content using the one or more key topics; and (g) generating a graphical user interface that includes a summary display, the summary display comprising the one or more key topics in a textual narrative.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is schematic diagram of an exemplary architecture that includes an information display system for practicing aspects of the present technology;

FIG. 2 illustrates textual content having been extracted from informational content, the textual content being assigned various identifiers;

FIG. 3 illustrates an exemplary graphical user interface comprising a summary display generated from a portion of the content of FIG. 2;

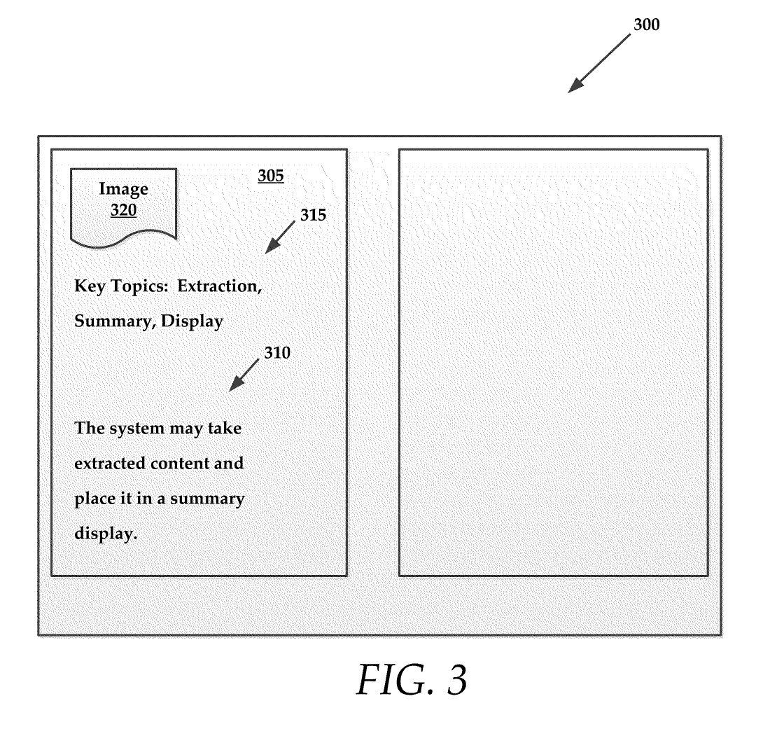

FIG. 4 illustrates another exemplary architecture for use in IPTV or television broadcast systems;

FIG. 5 is a flowchart of an exemplary method for summarizing and displaying informational content;

FIG. 6 is a flowchart of another exemplary method for summarizing and displaying informational content;

FIG. 7 illustrates a plurality of summary displays on a web page; and

FIG. 8 illustrates an exemplary computing system that may be used to implement embodiments according to the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

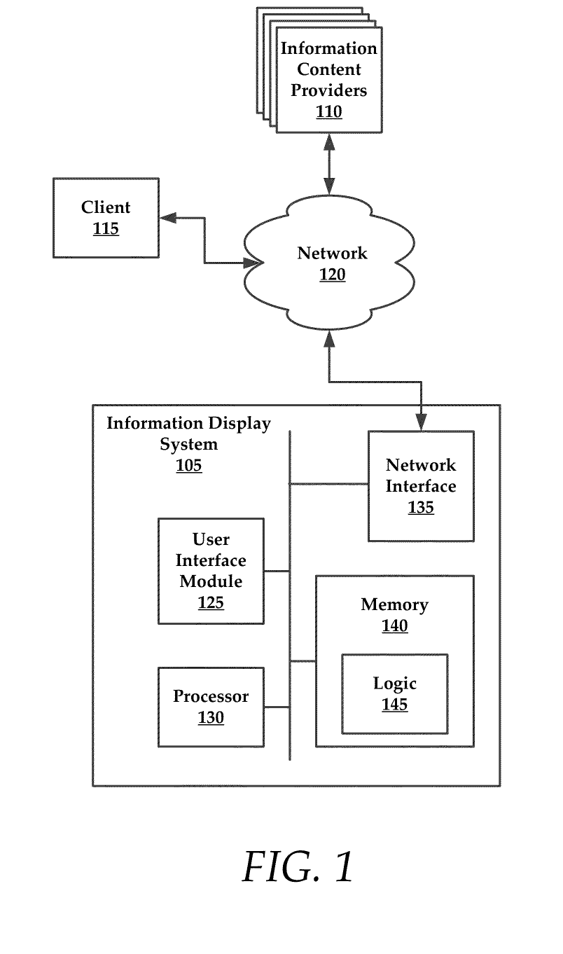

FIG. 1 illustrates an exemplary architecture for practicing aspects of the present technology. The architecture comprises an information display system, hereinafter “system 105” that is configured to extract information from information content providers 110 and provide summary displays of content to clients, such as client 115. The system 105 may communicatively couple with the client 115 and one or more of the content providers 110 utilizing a public or private network 120.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 136 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 105 generally comprises a user interface module 125, a processor, 130, a network interface 135, and a memory 140. According to some embodiments, the memory 140 comprises logic 145 that can be executed by the processor 130 to perform operations and methods such as the information gathering, analyzing, extracting, and displaying processes described in greater detail herein.

Broadly, the system 105 is configured to obtain informational content from any of a wide variety of information content providers 110. The system 105 may communicate with the information content providers 110 using the network interface 135.

Examples of information content providers 110 include, but are not limited to websites, blogs, social network feeds, really simple syndication (RSS) feeds, email servers, databases, digital content repositories, media servers (for audio and video files that can be parsed using speech recognition or speech-to-text technologies), as well as other information content providers that would be known to one of ordinary skill in the art. Advantageously, the informational content obtained from these various sources may include textual content that can be extracted and further analyzed by the system 105. In some instances the system 105 may obtain one or more instances of informational content from a single information provider system or may obtain informational content from multiple information provider systems.

In one example, the system 105 may retrieve a plurality of articles (informational content) from various websites that publish news articles or current events. Once obtained the system 105 may evaluate the informational content to determine if textual content can be extracted therefrom. If a sufficient amount of textual content cannot be extracted from the informational content the system 105 may flag the informational content and display such content differently from informational content that can be summarized and displayed according to the present technology.

In some instances, the system 105 may utilize a threshold calculation to determine if informational content lacks sufficient textual content. For example, the system 105 may require at least three or four sentences of textual content in order to create a summary display. It will be understood that the amount of textual content that is sufficient for a given type of textual content may be varied. For example, for more complex documents the system 105 may require extraction of relatively more textual content than that which is required from a simple current events article. Methods for displaying these types of informational content will be described in greater detail below.

In some embodiments, textual content may be extracted from informational content using optical character recognition (OCR) technology, or any other technology that allows textual content to be extracted from image or other electronic publications. Textual content may be extracted from other documents such as word processing documents, electronic books, PDF documents, spreadsheets, HTML files, and other similar files that include textual content. It will be understood that the extraction of content may include reading, copying, recognizing, or other similar operations that allow the system 105 to separate textual content from a file.

The system 105 may extract the textual content in such a way that the original ordering of the textual content is preserved. That is, the system 105 may preserve formatting such as pages, sections, paragraphs, sentences, and words.

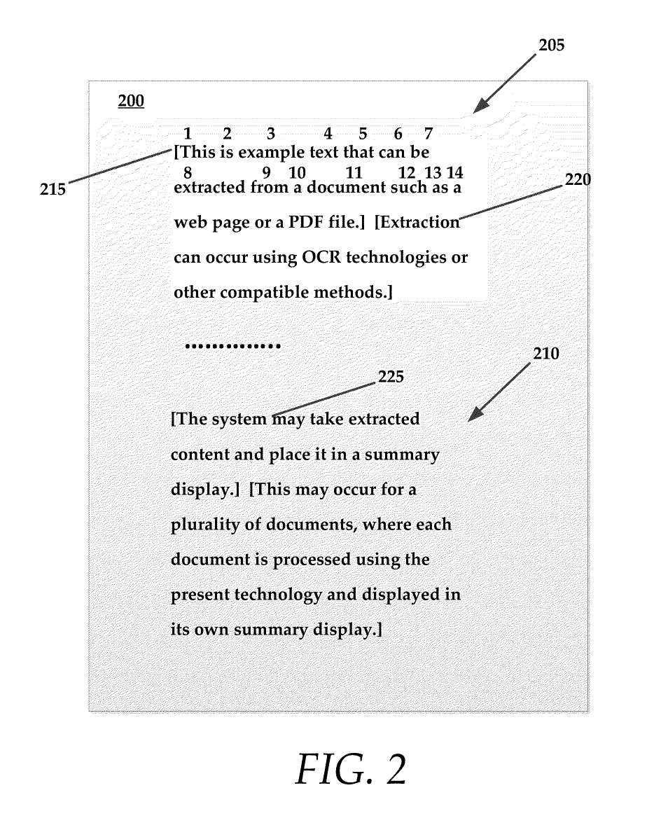

Next, the system 105 may count each word in each instance of informational content and assign a word identifier to each word in the informational content. FIG. 2 shows a process where paragraphs 205 and 210 of informational content 200 have been extracted from a news article. For purposes of brevity, only two paragraphs are shown, although the textual content may include many paragraphs and pages of content.

A first sentence 215 and second sentence 220 are shown in the first paragraph 205. For clarity, first sentence 215 is shown where each word has been assigned a word identifier. For example, the word “This” is assigned a word identifier of “1” and so forth. Each word in the document is assigned a number, such that each word has a higher number than the word preceding it.

Further, the system 105 may also assign sentence identifiers, such as numbers to each sentence in the informational content 200, as well as paragraph identifiers for paragraphs in the informational content 200. The system 105 may also associate particular words with sentences or paragraphs based upon the assigned identifiers. For example, the word “extracted” having an identifier of “8” is associated with first sentence 215 that is assigned an identifier of “1”. Also, the paragraph 205 is assigned a paragraph identifier of “1”. The system 105 may reference the eighth word of the first sentence of the first paragraph can be represented as “8:1:1.” It will be noted that the system 105 may interrelate the words, sentences, and paragraphs of the content in any manner.

In some embodiments, assigning word identifiers to each word of the textual content comprises numbering each word in the textual content in numerical order from a beginning of the textual content to an end of the textual content. Additionally, assigning sentence identifiers to each sentence of the textual content comprises numbering each sentence in the textual content in numerical order from a beginning of the textual content to an end of the textual content. Further, assigning paragraph identifiers to each paragraph of the textual content comprises numbering each paragraph in the textual content in numerical order from a beginning of the textual content to an end of the textual content.

After assigning of identifiers, the system 105 may analyze words in the textual content as well as their relative positions in the textual content to determine one or more key topics for the textual content. In some embodiments a key topic may be inferred from a frequency of occurrence of a particular word or occurrences of permutations of the same word or concept. For example, the word “extract”, “extraction”, and “extracted” may occur frequently in the textual content. In each of these instances, the concept of extraction is determined to be associated with “information” because the words “extract”, “extraction”, and “extracted” are always within at least three words of “extract”, “extraction”, and “extracted”. Thus, the system 105 may infer that a key topic of the textual content is information extraction.

Stated otherwise, the system 105 may create a somewhat topographical representation of the textual content by determining frequently occurring words, with the assumption that frequently occurring words are indicative of key topics. Indeed, because key topics are desired and not merely frequently occurring words, the system 105 may ignore frequently occurring articles and conjunctions, as well as punctuation.

It will be understood that the textual content may have more than one key topic and thus, the system 105 may detect multiple key topics within the textual content. Next, the system 105 may locate sentences in the textual content that where these words occur most frequently. These sentences indicate where the most relevant concepts of the textual document can be found. Thus, once frequently occurring words are located, their corresponding sentences can be identified based upon the identifiers assigned to the words and sentences as described above.

Once the most relevant sentences in the textual content have been identified, the system 105 may then generate a graphical user interface that includes a summary display. In some instances the summary display includes at least the extracted one or more sentences. More specifically, the system 105 may create a graphical user interface (GUI) using the user interface module 125. The user interface module 125 may generate a web page 300 that is separated into one or more sections or frames, such as summary display 305. By way of example, the summary display 305 may include sentence 310, which was extracted from the textual content of FIG. 2 and namely, sentence 225 of second paragraph 210. For context, it will be assumed that the system 105 had determined that the key topics “extracted”, “content”, “summary”, and “display” were all relevant topics for the textual content. The presence of all of these words in the same sentence allowed the system 105 to infer that sentence 225 was particularly relevant.

Thus, sentence 225 is provided in summary display 305. To provide context to the reader, the system 105 may also provide the key topic words in the summary display. In this example, key topics “Extraction”, “Summary”, and “Display” are listed in section 315. Also, the system 105 may obtain an image 320 that relates to the content of the summary. The image may be obtained from the information provider system from which the textual content was obtained, or the system 105 may search various network resources to find an appropriate image that corresponds to the key topics of the summary.

In some embodiments, the system 105 may obtain images for an instance of informational content that contains no images of its own, or potentially images having subject matter that is not necessarily indicative of the key topics of the content. For example, a news article may not include any (or not enough) images relating to the content of the story. In these instances, the system 105 may search various image related repositories and select one or more images having a subject matter that corresponds to one or more of the key points/topics of the informational content. According to some embodiments, the system 105 may arrange these images in a section within the summary display. For example, the system 105 may present the images in a slider bar frame that is displayed above the summarized content or the key topic words provided in the summary display. Thus, the end user can scroll through one or more images that related to the key topics of the summarized content.

According to some embodiments, the system 105 may search information provider systems for new or updated informational content. The system 105 may search for a particular topic or may be executed to search for new content. For example, the system 105 may obtain informational content from many sources and evaluate the informational content in an automatic and periodic manner. The system 105 may search several new oriented websites looking for news articles. Rather than having to provide the client 115 with a list of links to these stories, or the stories in their entireties, the system 105 may intelligently summarize the news articles using the above-described methods. Thus, the client 115 is presented with highly relevant, but smaller versions of the news articles. Users may select or click on the individual summary display to open the original source article if the user desires to read the entire article.

Advantageously, rather than only identifying topics or key words, the system 105 will extract an entire sentence or sentences that are highly representative of the key topics of the new articles. These highly important sentences are displayed in the summary display for the end user.

In some instances, an end user may query or search for content using the system 105. After receiving the query, the system 105 parses the query for keywords included in the query. Rather than obtaining informational content from information content providers with no expectation as to the content that is to be retrieved (such as polling of news websites to obtain current news), the system 105 may search information provider systems for informational content that corresponds to the query of the end user. Using the same methods provided above, the system 105 may create summary displays of each relevant instance of informational content found by the system 105.

The summary display may be provided to the client via a website, an RSS feed, an email, a social network post, or other medium that allows for the communication of GUIs.

As mentioned above, in some instances textual content may not be extractable from the informational content. In these instances, a summary display may include a link to the informational content, as well as an image that is indicative of the content.

In addition to the features described above, the system 105 may also be configured to create a single summary display from a plurality of instances of textual content. For example, the system 105 may create a summary display from the most frequently read articles on a particular topic. In one example the system 105 may obtain several articles regarding a news event. The system 105 may utilize the methods describe herein to create a single summary display, where sentences can be extracted from any or all of the news articles. Thus, the summary display may include the most relevant portions of these articles in one view, which is a textual narrative that describes an overall topic for each of the articles in combination.

The system 105 may also utilize the key topic determination processes herein to aid in logically separating a large document into sections based upon textual content included therein. For example, the system 105 may obtain a biographical book regarding a particular individual. The system 105 may utilize the key topic analysis methods described herein to logically separate the chapters of the book into topics, such as “early years”, “college years”, and “work years”—just to name a few.

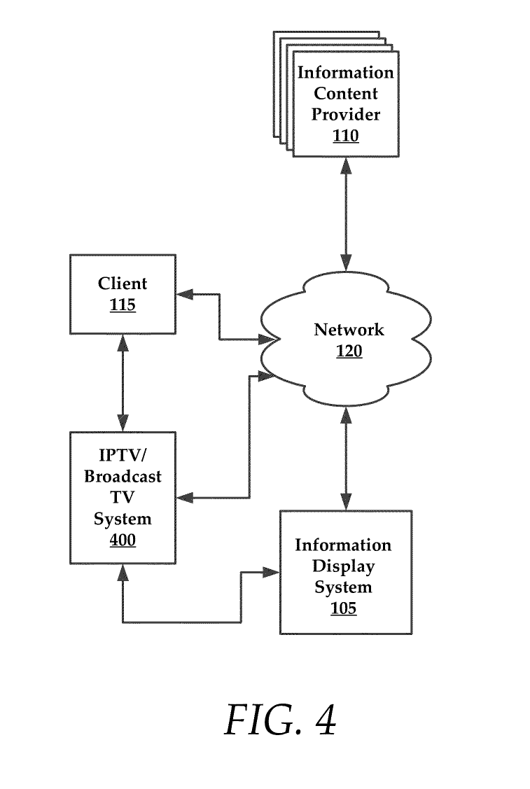

FIG. 4 illustrates another exemplary architecture that includes many of the same components of FIG. 1, with the exception that the architecture includes an Internet Protocol Television (IPTV)/Broadcast system that provides GUIs that comprise summary displays to end users of the client 105 using a dedicated summary channel. That is, the IPTV/Broadcast system 400 allows an end user to establish their own dedicated television channel. Using a set-top-box (STB) or other similar device, the end user may select their dedicated channel on their device and the IPTV/Broadcast system 400 may deliver a GUI that includes one or more summary displays which are generated as described above.

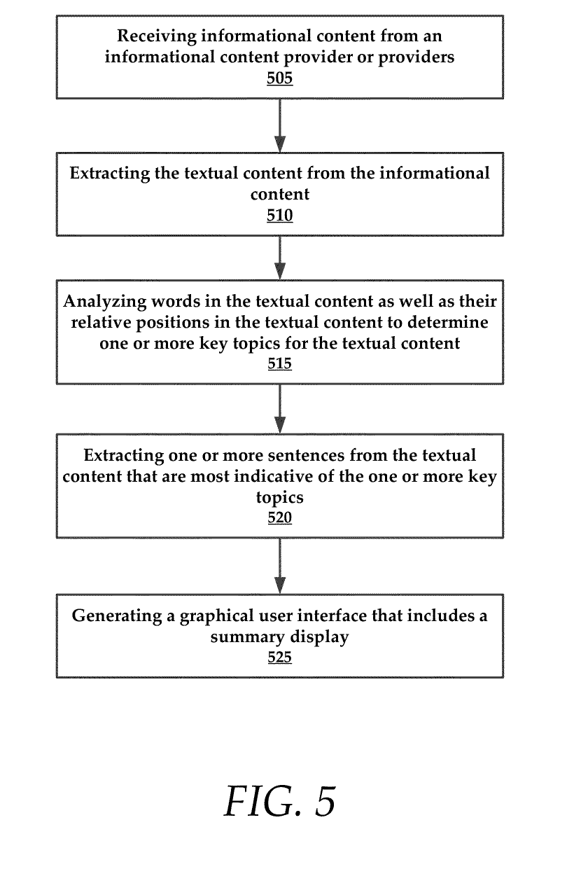

FIG. 5 is a flowchart of an exemplary method for summarizing and displaying content. The method includes receiving 505 informational content from an informational content provider or providers. As mentioned above, the informational content preferably comprises textual content, and in instances where textual content is not extractable from the informational content the method may include (not shown) displaying a link to the informational content, rather than generating a summary display.

Once the informational content has been obtained the method includes extracting 510 the textual content from the informational content, as well as analyzing 515 words in the textual content as well as their relative positions in the textual content to determine one or more key topics for the textual content.

After extraction and analysis of the words of the textual content the method includes extracting 520 one or more sentences from the textual content that are most indicative of the one or more key topics. Finally, the method includes generating 525 a graphical user interface that includes a summary display. As mentioned above the summary display comprises at least the extracted one or more sentences.

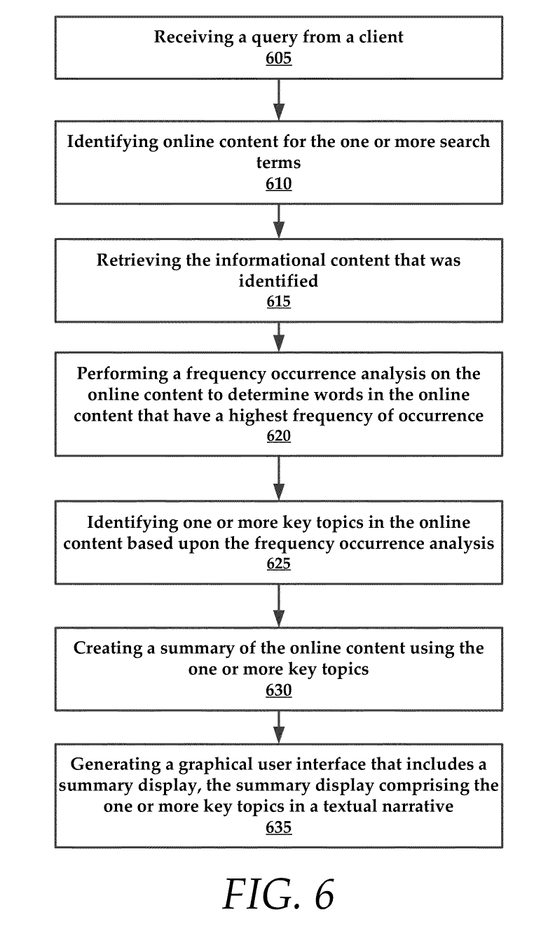

FIG. 6 is a flowchart of another method for summarizing and displaying content. The method includes receiving 605 a query from a client. In some instances the query includes one or more search terms, although the query may include a natural language query, which is analyzed for searchable keywords.

Next, the method includes identifying 610 online content for the one or more search terms. The online content comprising textual content such as news articles, web pages, blog entries, emails, social network posts, e-books, and other similar types of content that are likely to include textual content. Also, other types of information may be utilized such as audio or video files, where textual content is obtained using speech-to-text or other suitable processes for extracting text.

Additionally, the method may include retrieving 615 the informational content that was identified and performing 620 a frequency occurrence analysis on the online content to determine words in the online content that have a highest frequency of occurrence. After executing a frequency of analysis, the method then includes identifying 625 one or more key topics in the online content based upon the frequency occurrence analysis. Also, the method includes creating 630 a summary of the online content using the one or more key topics, as well as generating 635 a graphical user interface that includes a summary display, the summary display comprising the one or more key topics in a textual narrative.

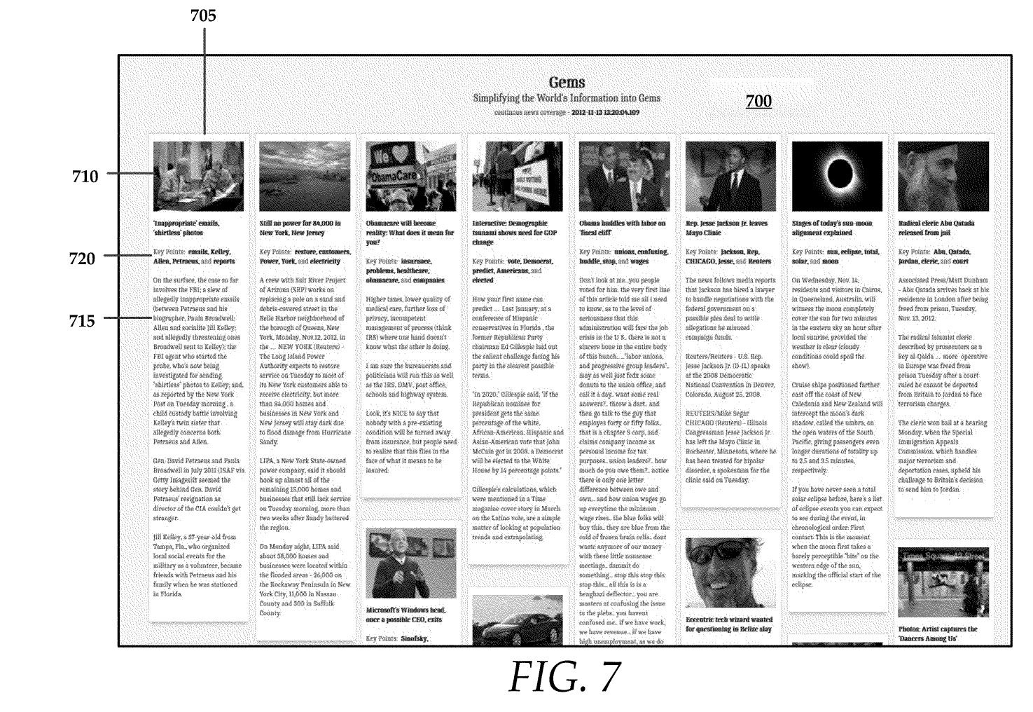

FIG. 7 illustrates an exemplary web page 700 that includes a plurality of summary displays, such as summary display 705. The summary display 705 includes an image that has been selected by the system 105. The image 710 corresponds to at least one key topic of the summarized content included in the display. The summary display 705 also includes sentences 715 that were selected from one or more articles. The summary display 705 may also include the “Key Point” words 720 which were used as the basis for extracting the sentences displayed.

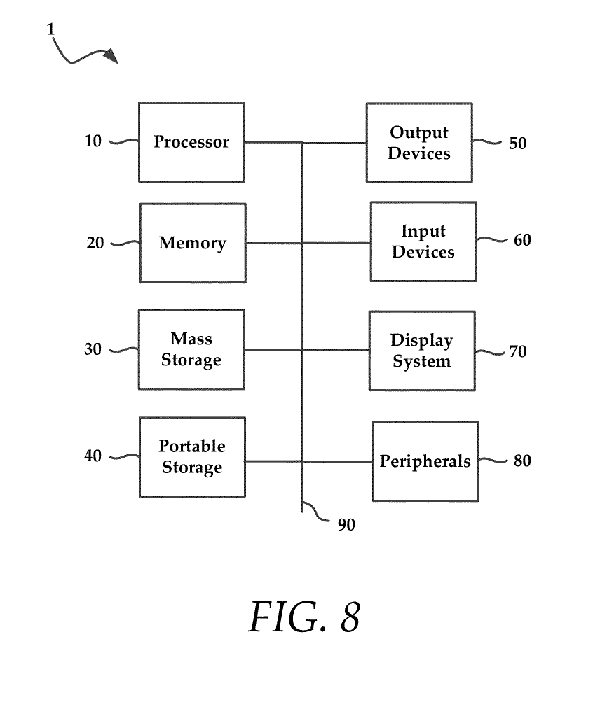

FIG. 8 illustrates an exemplary computing device 1 that may be used to implement an embodiment of the present systems and methods. The system 1 of FIG. 8 may be implemented in the contexts of the likes of clients, information display systems, computing devices, terminals, networks, servers, or combinations thereof. The computing device 1 of FIG. 8 includes a processor 10 and main memory 20. Main memory 20 stores, in part, instructions and data for execution by processor 10. Main memory 20 may store the executable code when in operation. The system 1 of FIG. 8 further includes a mass storage device 30, portable storage device 40, output devices 50, user input devices 60, a display system 70, and peripherals 80.

The components shown in FIG. 8 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 8. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 8 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device. Peripherals 80 may include any type of computer support device to add additional functionality to the computing system. Peripherals 80 may include a modem or a router.

The components contained in the computing system 1 of FIG. 8 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for displaying informational content using an information display system, which comprises a processor and a memory for storing logic that when executed by the processor causes the information display system to perform the method, comprising:
receiving informational content from an informational content provider, the informational content comprising textual content;
extracting the textual content from the informational content;
analyzing words in the textual content as well as their relative positions in the textual content to determine one or more key topics for the textual content;
extracting one or more sentences from the textual content that are most indicative of the one or more key topics; and
generating a graphical user interface that includes a summary display, the summary display comprising at least the extracted one or more sentences.

2. The method according to claim 1, further comprising generating summary displays for a plurality of informational content received from a plurality of informational content providers, wherein the summary displays are provided via the graphical user interface.

3. The method according to claim 1, further comprising assigning:
word identifiers to each word of the textual content;
sentence identifiers to each sentence of the textual content; and
paragraph identifiers to each paragraph of the textual content.

4. The method according to claim 3, wherein a relative position of words is determined with respect to the word identifiers, sentence identifiers, and paragraph identifiers.

5. The method according to claim 3, wherein assigning word identifiers to each word of the textual content comprises numbering each word in the textual content in numerical order from a beginning of the textual content to an end of the textual content.

6. The method according to claim 3, wherein assigning sentence identifiers to each sentence of the textual content comprises numbering each sentence in the textual content in numerical order from a beginning of the textual content to an end of the textual content.

7. The method according to claim 3, wherein assigning paragraph identifiers to each paragraph of the textual content comprises numbering each paragraph in the textual content in numerical order from a beginning of the textual content to an end of the textual content.

8. The method according to claim 1, wherein determining one or more key topics comprises identifying one or more words in the textual content having a highest frequency of occurrence in the textual content.

9. The method according to claim 1, wherein the summary display further comprises the one or more words identified as being associated with the one or more key topics of the textual content.

10. The method according to claim 1, further comprising searching for the informational content provider in response to a query received from a client.

11. The method according to claim 1, wherein the summary display further comprises an image that is associated with the one or more key topics.

12. A system for displaying informational content, the system comprising:
a processor; and
a memory for storing logic, the logic being executed by the processor to:
receive informational content from an informational content provider, the informational content comprising textual content;
extract the textual content from the informational content;
analyze words in the textual content as well as their relative positions in the textual content to determine one or more key topics for the textual content;
extract one or more sentences from the textual content that are most indicative of the one or more key topics; and
generate a graphical user interface that includes a summary display, the summary display comprising the extracted one or more sentences.

13. The system according to claim 12, wherein the processor further executes the logic to create summary displays for a plurality of informational content received from a plurality of informational content providers.

14. The system according to claim 12, wherein the processor further executes the logic to assign word identifiers to each word of the textual content by numbering each word in the textual content in numerical order from a beginning of the textual content to an end of the textual content.

15. The system according to claim 12, wherein the processor further executes the logic to assign sentence identifiers to each sentence of the textual content by numbering each sentence in the textual content in numerical order from a beginning of the textual content to an end of the textual content.

16. The system according to claim 12, wherein the processor further executes the logic to assign paragraph identifiers to each paragraph of the textual content by numbering each paragraph in the textual content in numerical order from a beginning of the textual content to an end of the textual content.

17. The system according to claim 12, wherein the processor further executes the logic to identify one or more key topics in the textual content comprises identifying one or more words in the textual content having a highest frequency of occurrence in the textual content.

18. The system according to claim 12, wherein the summary display further comprises the one or more words identified as being associated with the one or more key topics of the textual content.

19. The system according to claim 12, wherein the processor further executes the logic to search for the informational content provider in response to a query received from a client.

20. The system according to claim 12, wherein the processor further executes the logic retrieve an image from an image associated with the one or more key topics, wherein the image is included in the summary display.

21. A method for summarizing and displaying informational content using an information display system, which comprises a processor and a memory for storing logic that when executed by the processor causes the information display system to perform the method, comprising:
receiving a query from a client, the query comprising one or more search terms;
identifying online content for the one or more search terms, the online content comprising textual content;
retrieving the informational content that was identified;
performing a frequency occurrence analysis on the online content to determine words in the online content that have a highest frequency of occurrence;
identifying one or more key topics in the online content based upon the frequency occurrence analysis;
creating a summary of the online content using the one or more key topics; and
generating a graphical user interface that includes a summary display, the summary display comprising the one or more key topics in a textual narrative.

22. The method according to claim 21, further comprising determining if the online content lacks sufficient textual content; and outputting a message to the client that the online content cannot be analyzed, wherein the message includes a link to the online content.
